(19) United States
(12) Patent Application Publication
(10) Pub. No.: US 2016/0072245 A1
(43) Pub. Date: Mar. 10, 2016

(54) APPARATUS FOR USE IN THE CRIMPING OF END FITTINGS ONTO A CABLE

(71) Applicant: PDS Electronics, Inc., Tallmadge, OH (US)

(72) Inventors: Timothy S. STONE, Sagamore Hills, OH (US); Christopher R. CUMMINGS, Newton Falls, OH (US)

(21) Appl. No.: 14/482,427

(22) Filed: Sep. 10, 2014

(51) Int. Cl. H01R 43/048

(52) U.S. Cl. CPC H01R 43/048

(57) ABSTRACT

An apparatus for use with a machine that crimps an end fitting onto a cable includes a base (11) which carries a table (30) that has a plurality of channels (38, 39) which receive a cable (43) and an end fitting (44). A stop bar (53) and a stop plate (57) are adjustably positioned in each channel (38, 39) to locate the end fittings (44) so that they are aligned to be simultaneously acted upon by the machine. The table (30) is moveable on the base (11) from a first position where the cables (43) and end fittings (44) may be placed in the channels (32, 39) to a second position where the end fittings (44) are in a position to be crimped onto the cables (43).

### TECHNICAL FIELD

This invention relates to a device which is used with a machine to crimp end fittings, such as electrical connectors, onto a wire or coaxial cable.

### BACKGROUND ART

There are many methods of attaching end fittings to a coaxial cable or wire. For example, the end fitting can be threaded onto the casing of the wire or it can be crimped onto the wire. Machines are available which perform the crimping process. When using such machines, the operator places the end fitting onto the cable and holds it in place in the machine which is then actuated to place a crimping force on the end fitting to thereby attach it to the cable. Such not only presents a potential safety hazard to the user, but also it is inefficient in that only one cable is crimped per cycle of the crimping process. Moreover, such procedures often result in a defective connections if the operator does not carefully hold the items in place in the machine. Of course, in so doing, the safety problem is increased.

Thus, the need exists for a crimping device which is safe to use with a crimping machine and which will accurately and efficiently crimp end fittings onto a cable.

### DISCLOSURE OF THE INVENTION

It is thus an object of one aspect of the present invention to provide a crimping device which efficiently allows a crimping machine to crimp end fittings onto multiple cables at the same time.

It is an object of another aspect of the present invention to provide a device, as above, which is safe to operate in that the wires and end fittings do not have to be manually held in place.

It is an object of a further aspect of the present invention to provide a device, as above, which eliminates defective connections between the end fittings and the cable.

These and other objects of the present invention, as well as the advantages thereof over existing prior art forms, which will become apparent from the description to follow, are accomplished by the improvements hereinafter described and claimed.

In general, in accordance with one aspect of the present invention, an apparatus for use with a machine that applies a crimping force to attach an end fitting to a cable includes a base and a table adapted to carry at least one cable and an end fitting. The table is moveable on the base from a first position, where the cable and end fitting may be placed on the table, to a second position where the cable and end fitting are in a position to be acted upon by the machine.

In accordance with another aspect of the invention, an apparatus for use with a machine that applies a crimping force to attach an end fitting to a cable includes a table having at least one channel adapted to receive a cable and an end fitting. At least one stop member is positioned in the channel to locate the end fitting so that the end fitting is properly positioned to be crimped onto the cable by the machine.

Another aspect of the invention provides an apparatus for use with a machine that applies a crimping force to attach one end fitting to a cable includes a table having a plurality of channels each being adapted to receive a cable and an end fitting. The end fittings are aligned in the channels so that they may be simultaneously crimped onto the cables by the machine.

In an additional aspect of the invention, an apparatus for use with a machine that applies a crimping force to attach an end fitting to a cable includes a base and a table having a plurality of channels each being adapted to receive a cable and an end fitting. At least one stop member is positioned in each channel to locate the end fittings to that they are aligned and properly positioned to be simultaneously acted upon by the machine. The table is moveable on the base from a first position, where the cables and end fittings may be placed in the channels, to a second position where the cables and the end fittings are in a position to be simultaneously crimped onto the cutter by the machine.

A preferred exemplary device used with a crimping machine according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a perspective view of a crimping device made in accordance with the concepts of the present invention showing it is its initial position ready for use;

FIG. 2 is a perspective view thereof sequentially following FIG. 1 and showing two cables held in place;

FIG. 3 is a perspective view thereof sequentially following FIG. 2 and showing that the cables have been moved to a position under the crimping head of a crimping machine;

FIG. 4 is a perspective view sequentially following FIG. 3 and showing the crimping head acting on the cables to crimp an end fitting thereto;

FIG. 5 is a perspective view sequentially following FIG. 4 and showing the crimping head being retracted;

FIG. 6 is a fragmented perspective view of a cable having an end fitting crimped thereon;

FIG. 7 is a sectional view taken substantially along line 7-7 of FIG. 1; and

FIG. 8 is a view taken substantially along line 8-8 of FIG. 1.

### PREFERRED EMBODIMENT FOR CARRYING OUT THE INVENTION

A device for use with a crimping machine is generally indicated by the numeral 10. Device 10 includes a base generally indicated by the numeral 11 and having a top surface 12 which extends from one end 13 to the other end 14 (FIG. 8) of base 11. Top surface 12 is provided with two recessed keyways 15 which extend from end 13 through an overhang 16 which is a continuation of top surface 12 that extends outwardly beyond end 14 of base 11.

Base 11 may be provided with a foot 17 that can support device 10 on a table or other supporting surface. Side plates 18 and 19 are attached at each side of base 11 by any suitable means such as bolts 20. Plates 18 and 19 extend from base end 13 to base end 14, and they terminate under overhang 16 of top surface 12 of base 11.

Device 10 is adapted to be used with a conventional crimping machine such as Model CT55 manufactured by the Schleuniger Group of Switzerland. A portion 21 of the machine is schematically shown in FIG. 8 which depicts the manner in which the machine is attached to device 10. Specifically, portion 21 of the machine is provided with a key 22 that is received in a keyway 23 formed in a flange positioned at the bottom of overhang 16 of top surface 12. With o plates 18 and 19 removed from base 11, portion 21 of the machine may be slid onto key 22 until it is under overhang 12. Then bolts 24 may be used to connect the machine to plates 18 and 19 of device 10. At this time, bolts 20 may be utilized to attach the other end of plates 18 and 19 to base 11. Such positively positions the piston head 25 (schematically shown) of the machine relative to device 10 as will hereinafter be described in more detail.

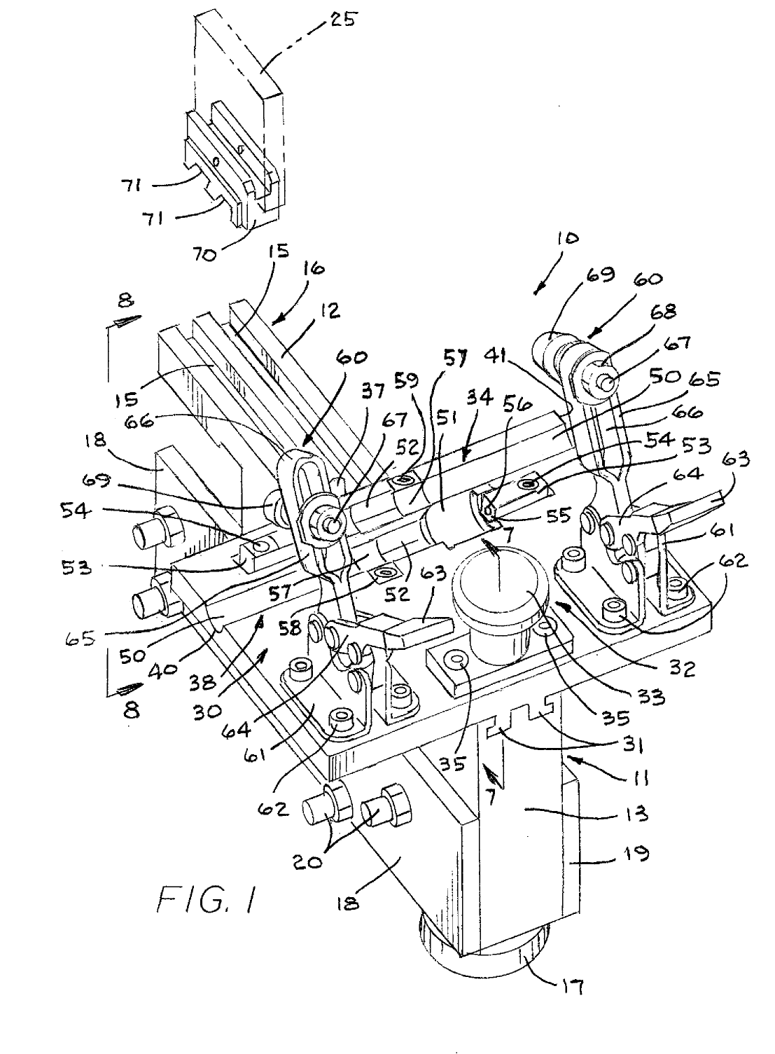

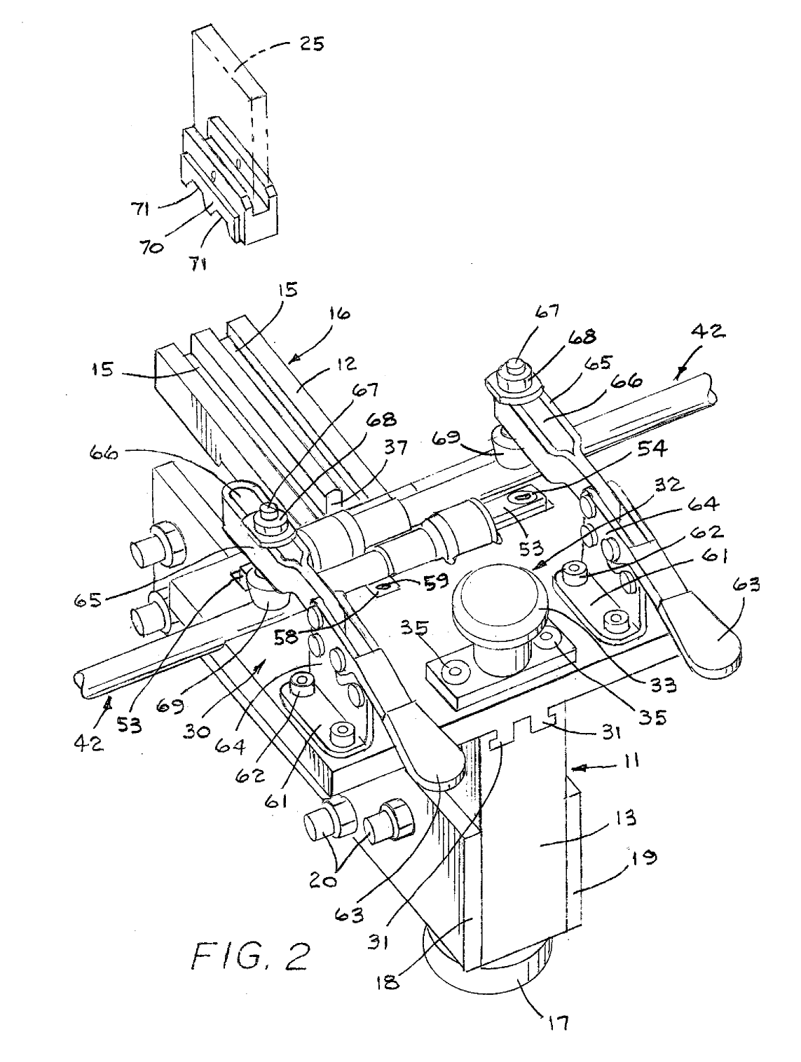

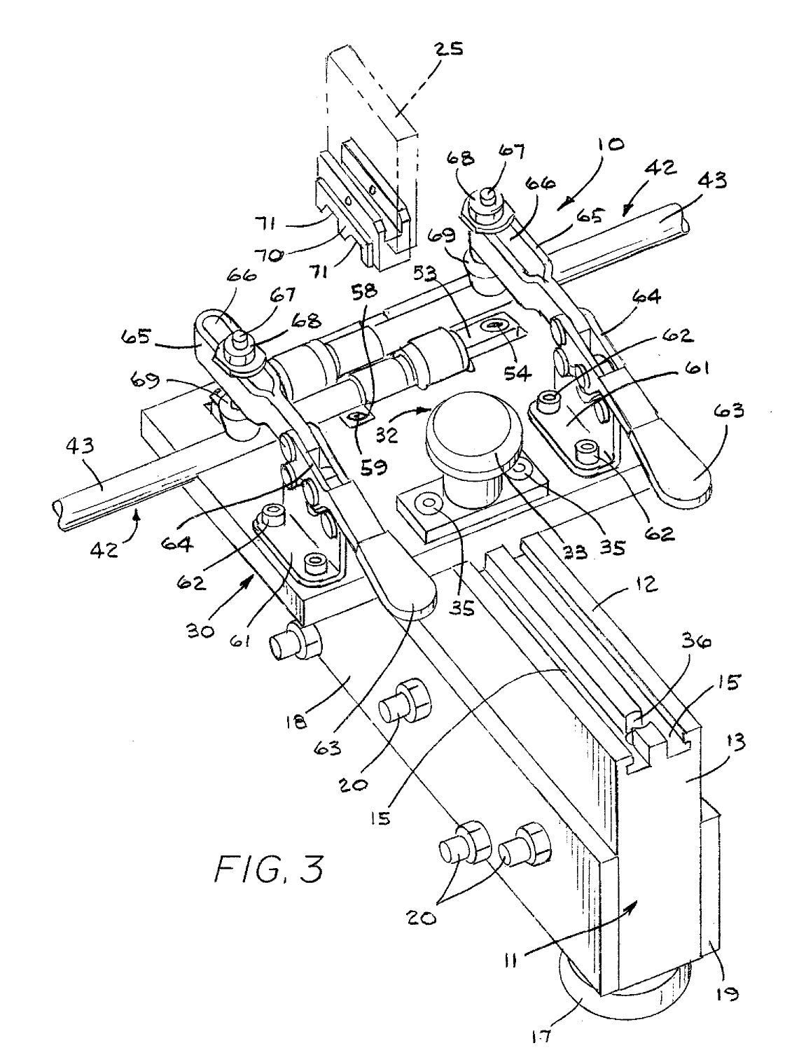

Base 11 carries a crimping table generally indicated by the numeral 30. A pair of keys 31 extend downwardly from table 30 and are received in keyways 15 such that table 30 may be slidable along base top surface 12 and overhang 16. A plunger assembly, generally indicated by the numeral 32, shown in more detail in FIG. 7, maintains the table 30 at the desired position along top surface 12. Plunger assembly 32 includes a knob 33 which carries a spring loaded plunger 34. Assembly 32 can be attached to table 30 as by bolts 35. When table 30 is in the position shown in FIGS. 1 and 2, plunger 34 is biased into an aperture 36 (FIGS. 3-5) formed between keyways 15 at the top of base 11. When it is desired to move table 30, knob 33 can be lifted to remove plunger 34 from aperture 36 and then table 30 may be moved along the top surface 12 of base 11 to the FIGS. 3-5 position. When the plunger reaches a second aperture 37 (FIGS. 1 and 2) formed between keyways 15, the plunger 34 snaps into aperture 37 locking table 30 in the FIGS. 3-5 position.

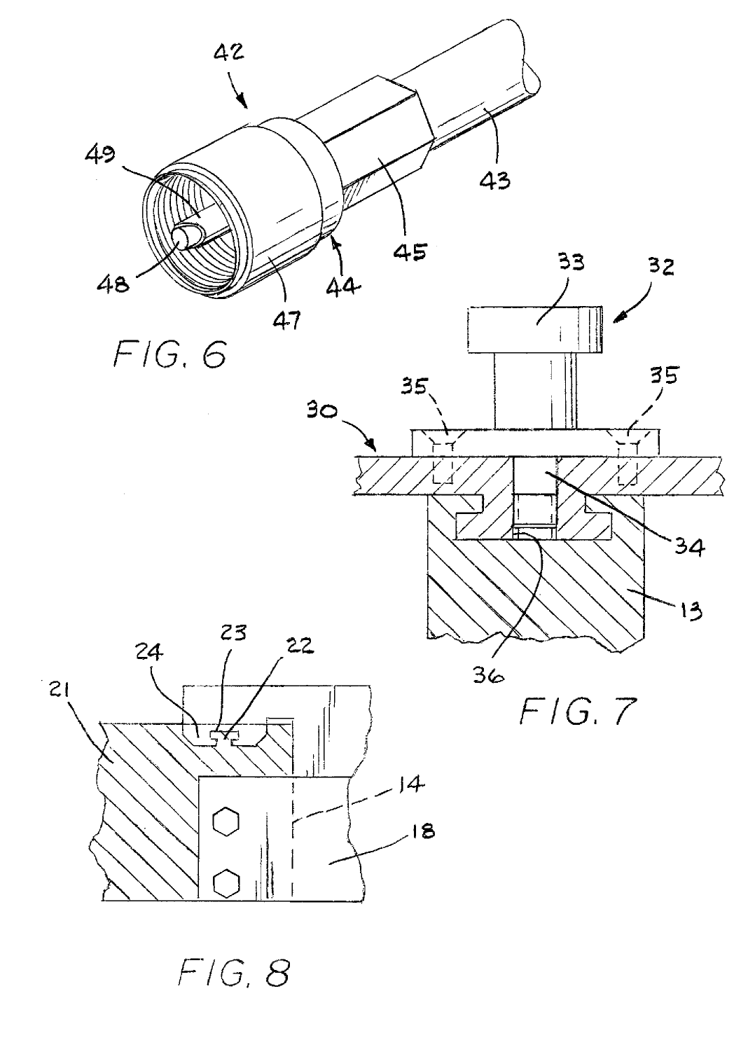

Two parallel channels 38 and 39 are formed in the end of table 30 opposite to the end having plunger assembly 32. As shown in FIG. 1, channel 38 opens, as at 40, at one side of table 30, and channel 39 opens, as at 41, at the other side of table 30. Channels 38 and 39 are each configured to receive an end fitting and cable assembly generally indicated by the numeral 42 and best shown in FIG. 6. Assembly 42 includes a coaxial cable 43 shown in FIG. 6 with an end fitting 44 crimped thereon. End fitting 44 is a conventional item including a ferrule 45, a body 46, and a coupler nut 47. Ferrule 45 is in contact with one conductor of coaxial cable 43, and a center pin 48 forms the other conductor of cable 43. The two conductors are maintained separate by insulation 49.

Thus, channels 38 and 39 each have a portion 50 sized to receive cable 43, ferrule 45, and body 46, and another portion 51 sized to receive coupler nut 47. The area of portion 50 which is adapted to receive ferrule 45 is formed as one half of a hexagonal pattern 52 which, as will hereinafter be discussed, is part of a crimping die. The ends of channels 38 and 39 opposite to open ends 40 and 41 each receive a stop bar 53 adjustably held in place by a bolt 54. To that end, bar 53 has a slotted hole that bolt 54 extends through and goes into a threaded hole in table 30. When bolt 54 is loosened, bar 53 may be slid to the desired position and tightened at that location by bolt 54. Each stop face 55 is provided with an aperture 56 (FIG. 1) that receives pin 48 of cable assembly 42 to assure the proper location of cable assembly 42. As such, a stop face 55 of bar 53 is properly positioned adjacent to coupler nut 47.

The other side of ferrule 45 is positioned against ferrule stop plate 57 which is arcuate in configuration to match the shape of portion 50 of channels 38 and 39. Plate 57 is carried by a flange 58 which is adjustably attached to table 30 by a bolt 59. Plate 57 is adjusted along channel portion 50 in the same manner as bar 53 is adjusted. As such, each cable assembly 42, and in particular, ferrule 45 thereof, is positively positioned on hexagonal pattern 52 between bars 53 and plates 57. The ferrules 45 of the cable assemblies 42 are thus located adjacent to each other for simultaneous crimping by the crimping machine as will be hereinafter described.

A pair of conventional toggle clamp assemblies, generally indicated by the numeral 60, are carried by table 30. Each toggle clamp assembly 60 includes a bifurcated base 61 mounted to table 30 as by bolts 62. Each base 61 carries a handle 63 connected through a conventional linkage 64 to a clamp arm 65. Each clamp arm 65 is provided with a slot 66 to receive a clamp pin 67 therethrough. Clamp pins 67 are threaded at one end and are adjustable in slots 66 by means of a bolt assembly 68. The other ends of pins 67 are each provided with a clamp member 69 preferably made of a rubber or other elastomeric material.

In the operation of device 10, with table 30 in the FIG. 1 position, a cable assembly 42 may be placed in each channel 38 and 39 as previously described, and handles 63 of toggle clamp assemblies 60 are moved from the FIG. 1 to the FIG. 2 position. Such actuation rotates clamp arms 65 until the clamp members 69 engage the cables 43 of cable assemblies 42 as shown in FIG. 2. It should be observed that pins 67 have been positioned in different locations in slots 66 so that one clamp assembly 60 is engaging one cable assembly 42 and the other clamp assembly 60 is engaging the other cable assembly 42. This position is shown in FIG. 2.

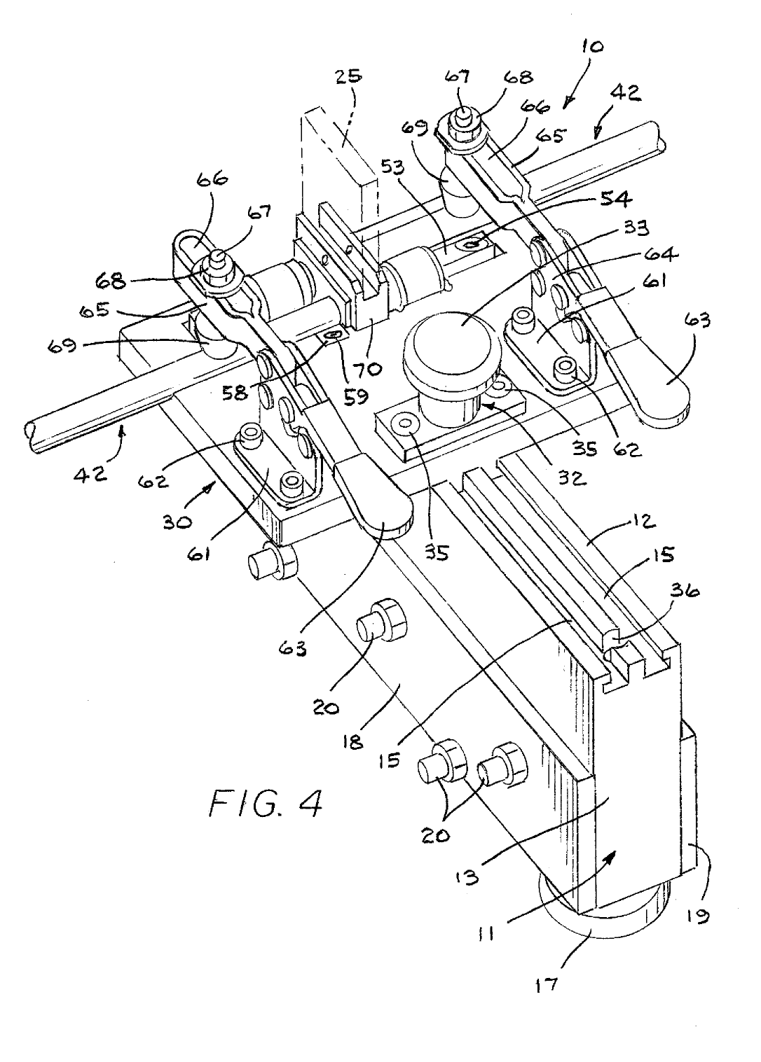

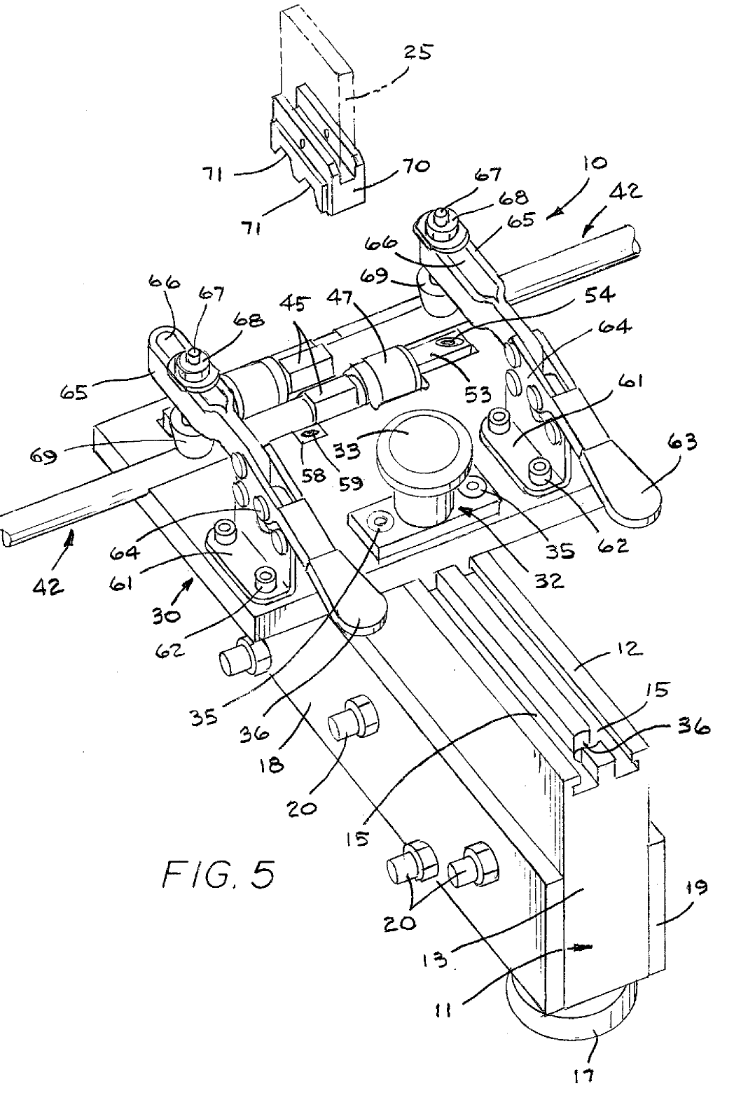

Next, the knob 33 of plunger assembly 32 is lifted to remove plunger 34 from aperture 35 to allow table 30 to be moved from the FIG. 2 to the FIG. 3 position. In this position, ferrules 45 are aligned with each other and are positioned directly under the crimping piston head 25 (schematically shown) of the crimping machine. Piston 25 carries a crimp head 70 which forms, as by 71, the other half of the eventual hexagonally crimped ferrules 45. Thus, as shown in FIG. 4, piston 70 has been activated to simultaneously crimp the ferrules 45 of both cable assemblies 42 at the same time resulting in ferrules of a configuration shown in FIGS. 5 and 6. The piston is then withdrawn, as shown in FIG. 5, table 30 is moved back to the FIG. 2 position, and the cable assemblies are unclamped so that the finished cable assemblies 42 can be removed. Then, the process can be repeated for two new unfinished cable assemblies 42.

As a result of this operation, not only can two cable assemblies 42 be processed at one time, but also such can be accomplished safely and accurately. That is, the cable assemblies 42 need not be held in place by the operator which could lead to inaccuracy or a safety problem, but rather they are positively positioned by virtue of the position of stop bars 52 and held in place by clamp members 69. Moreover, because the cable assemblies 42 are positioned in channels 38 and 39 and then table 30 is moved to position them under piston 25, there is no possibility that the hand or fingers of the user could be accidentally exposed to the force of piston 25.

In view of the foregoing, it should thus be evident that a crimping device 10 as described herein accomplishes the objects of the invention and otherwise substantially improves the art.

What is claimed is:

1. Apparatus for use with a machine that applies a crimping force to attach an end fitting to a cable, the apparatus comprising a base, and a table adapted to carry at least one cable and an end fitting, said table being moveable on said base from a first position, where the cable and end fitting may be placed on said table, to a second position where the cable and end fitting are in a position to be acted upon by the machine.

2. The apparatus of claim 1 further comprising a plunger assembly adapted to maintain said table in said first or second position.

3. The apparatus of claim 2 wherein said base is provided with spaced apertures and said plunger assembly includes a spring loaded pin receivable in either of said apertures.

4. The apparatus of claim 3 wherein said plunger assembly includes a knob to control said pin.

5. The apparatus of claim 1 further comprising at least one clamp assembly to hold said cable and end fitting on said table.

6. The apparatus of claim 5 wherein each said clamp assembly includes a handle and an arm, said handle moving said arm through a linkage, and a clamp member carried by said arm and adapted to engage the cable.

7. The apparatus of claim 1 wherein said base is provided with keyways and said table is provided with keys positioned in said keyways to guide said table as it moves on said base.

8. The apparatus of claim 1 further comprising side plates to attach the machine to said base.

9. The apparatus of claim 1 further comprising at least one channel in said table adapted to receive a cable and an end fitting, and at least one stop member positioned in said channel to locate the end fitting so that the end fitting is properly positioned to be acted upon by the machine.

10. The apparatus of claim 1, said table having a plurality of channels each being adapted to receive a cable and an end fitting, the end fittings being aligned in said channels so that they may be simultaneously acted upon by the machine.

11. Apparatus for use with a machine that applies a crimping force to attach an end fitting to a cable, the apparatus comprising a table having at least one channel adapted to receive a cable and an end fitting, and at least one stop member positioned in said channel to locate the end fitting so that the end fitting is properly positioned to be crimped onto the cable by the machine.

12. The apparatus of claim 11 wherein the position of said stop member on said channel is adjustable.

13. The apparatus of claim 11, the end fitting having a pin and said stop member having an aperture adapted to receive the pin.

14. The apparatus of claim 11 wherein the end fitting includes a coupler nut and a ferrule, a first said stop member being positioned adjacent to the coupler nut and a second stop member being positioned adjacent to the ferrule so that the ferrule is in a proper position to be crimped.

15. The apparatus of claim 11, said table having a plurality of channels each being adapted to receive a cable and an end fitting, the end fittings being aligned in said channels so that they may be simultaneously acted upon by the machine.

16. The apparatus of claim 11 further comprising at least one clamp assembly to hold the cable and end fitting on said table.

17. The apparatus of claim 16 wherein each said clamp assembly includes a handle, an arm, said handle moving said arm through a linkage, and a clamp member carried by said arm and adapted to engage the cable.

18. Apparatus for use with a machine that applies a crimping force to attach an end fitting to a cable, the apparatus comprising a table having a plurality of channels each being adapted to receive a cable and an end fitting, the end fittings being aligned in said channels so that they may be simultaneously crimped onto the cables by the machine.

19. The apparatus of claim 18 wherein said channels are parallel to each other.

20. The apparatus of claim 18 further comprising a clamp assembly for each cable and end fitting to engage the cable and maintain the end fittings aligned in said channels, each said clamp assembly having a handle moving an arm which carries a clamp member, and means to adjust the position of said clamp member on said arm so that said clamp member engages the cable.

21. Apparatus for use with a machine that applies a crimping force to attach an end fitting to a cable, the apparatus comprising a base, a table having a plurality of channels each being adapted to receive a cable and an end fitting, and at least one stop member positioned in each said channel to locate the end fittings so that they are aligned and properly positioned to be simultaneously acted upon by the machine, said table being moveable on said base from a first position where the cables and end fittings may be placed in said channels to a second position where the cables and the end fittings are in a position to be simultaneously crimped onto the machine.
